(19) United States
(12) Patent Application Publication
(10) Pub. No.: US 2016/0216718 A1
(43) Pub. Date: Jul. 28, 2016

(54) SYSTEM AND METHOD FOR LIMITING HVAC MOTOR TORQUE

(71) Applicant: Carrier Corporation, Farmington, CT (US)

(72) Inventors: Bradley D. Powell, Greenwood, IN (US); Rajendra K. Shah, Indianapolis, IN (US)

(21) Appl. No.: 14/993,805

(22) Filed: Jan. 12, 2016

Related U.S. Application Data
(60) Provisional application No. 62/106,561, filed on Jan. 22, 2015.

(51) Int. Cl. G05D 23/13; F04D 27/00; F04D 25/06; H02P 6/08

(52) U.S. Cl. CPC G05D 23/1393; H02P 6/08; F04D 27/001; F04D 27/004; F04D 25/0666; G05B 2219/2614

(57) ABSTRACT

A system and method for operating a blower motor disposed in an air handling unit is provided. The system and method includes determining a torque limit of the blower motor based at least partially on an operational speed of the blower motor, determining a target torque based at least in part on a target airflow, and operating the blower motor at the torque limit if it is determined that the target torque is greater than the torque limit

### CROSS REFERENCE TO RELATED APPLICATIONS

The present application is related to, and claims the priority benefit of, U.S. Provisional Patent Application Ser. No. 62/106,561 filed Jan. 22, 2015, the contents of which are hereby incorporated in their entirety into the present disclosure.

### TECHNICAL FIELD OF THE DISCLOSED EMBODIMENTS

The presently disclosed embodiments generally relate to a heating, ventilation, and air conditioning (HVAC) system. More particularly, the embodiments relate to a system and method for limiting motor torque in an HVAC system.

### BACKGROUND OF THE DISCLOSED EMBODIMENTS

Modern structures, such as office buildings and residences, utilize heating, ventilation, and cooling (HVAC) systems having controllers that allow users to control the environmental conditions within these structures. These controllers have evolved over time from simple temperature based controllers to more advanced programmable controllers, which allow users to program a schedule of temperature set points in one or more environmental control zones for a fixed number of time periods as well as to control the humidity in the control zones, or other similar conditions. Typically, these HVAC systems use an air handler connected to ducts to delivered conditioned air to an interior space. These ducts provide a path for air to be drawn from the conditioned space and then returned to the air handler. These duct systems vary in shape, cross section and length to serve the design constraints of a structure. The air handler includes a motor and a fan to move the air through the ducts, conditioning equipment, and the space.

Air handlers may use electronically commutated motors (ECM) with internal compensation algorithms that improve the blower system performance over induction motor driven models. The algorithms in these ECM driven blowers are capable of varying power output to provide improved blower performance to meet loading requirements over most of the air handler's operating envelope of mass flow versus static pressure loading.

The ECM driven blowers frequently have internal torque limits built into the motor controller to determine if a current motor torque is higher than a torque limit. In situations when the HVAC system operates at the extreme operating ranges, the torque limit may be exceeded. In those situations, the motor automatically reduces the torque incrementally from the excess torque value required for the desired airflow to a lower torque value at the torque limit of the motor.

When an internal motor torque limit is enforced, the ECM driven blower reports the reduced motor speed as a result of the reduced torque to the controller of the air handler. However, the ECM driven blower does not report the corrected airflow at the corrected torque. Therefore, during operating conditions when a motor torque limit is enforced, a system operator or the system controller does not know the actual, corrected airflow delivered by the ECM driven blower. Further, the ECM driven blower is already operating beyond the motor torque limit when the ECM takes corrective action. Allowing a motor to operate beyond its torque limit for a period of time may be dangerous or destructive to the motor.

There remains a need for an HVAC system that limits the torque of the blower motor before the torque limit of the motor is exceeded. Further, there remains a need for an HVAC system that determines the airflow of the system following an enforcement of the blower motor torque limit.

### SUMMARY OF THE DISCLOSED EMBODIMENTS

In one aspect, a method for operating a blower motor disposed in an air handling unit is provided. The method includes the steps of determining a torque limit of a blower motor based at least in part on an operational speed of the motor. In the embodiment, determining the torque limit is based at least in part on at least one of a static pressure value, extrapolating blower motor speed values correlated with blower motor torque values, and receiving at least one torque limit value from a system controller.

The method further includes the step of determining a target torque based at least in part on a target airflow. In one embodiment, the step of determining the target airflow includes receiving a target airflow command from a system controller.

The method further includes the step of operating the blower motor at the torque limit if it is determined that the target torque is greater than the torque limit. In one embodiment, the method further includes the step of determining a corrected speed of the motor when the blower motor is operating at the torque limit. In one embodiment, the method further includes the step of determining a corrected airflow based at least in part on the corrected motor speed. In one embodiment, the method further includes the step of displaying the corrected airflow on a user interface element operably coupled to the air handling unit. In one embodiment, the method includes the step of operating the blower motor at the target torque if it is determined that the target torque is less than or equal to the torque limit.

In one aspect, an air handler unit is provided. The air handler includes a blower unit, a motor operably coupled to the blower unit, and a controller in electrical communication with the motor. The controller is configured determine a torque limit of the motor based at least partially on a speed of the motor, determine a target torque based at least in part on a target airflow, operate the motor at the torque limit if it is determined that the target torque is greater than the torque limit. In one embodiment, the controller is further configured to operate the motor at the target torque if it is determined that the target torque is less than or equal to the torque limit.

### BRIEF DESCRIPTION OF THE DRAWINGS

The embodiments and other features, advantages and disclosures contained herein, and the manner of attaining them, will become apparent and the present disclosure will be better understood by reference to the following description of various exemplary embodiments of the present disclosure taken in conjunction with the accompanying drawings, wherein:

FIG. 1 is a schematic diagram of an air handler according to one embodiment of the present disclosure;

FIG. 2 shows a schematic flow diagram of a method for operating a blower motor disposed in an air handling unit; and

FIG. 3 illustrates a graph of a duct square law curve, airflow curves, and a torque limit line plotted over motor torque values and motor speed values according to one embodiment of the present disclosure.

### DETAILED DESCRIPTION OF THE ENCLOSED EMBODIMENTS

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

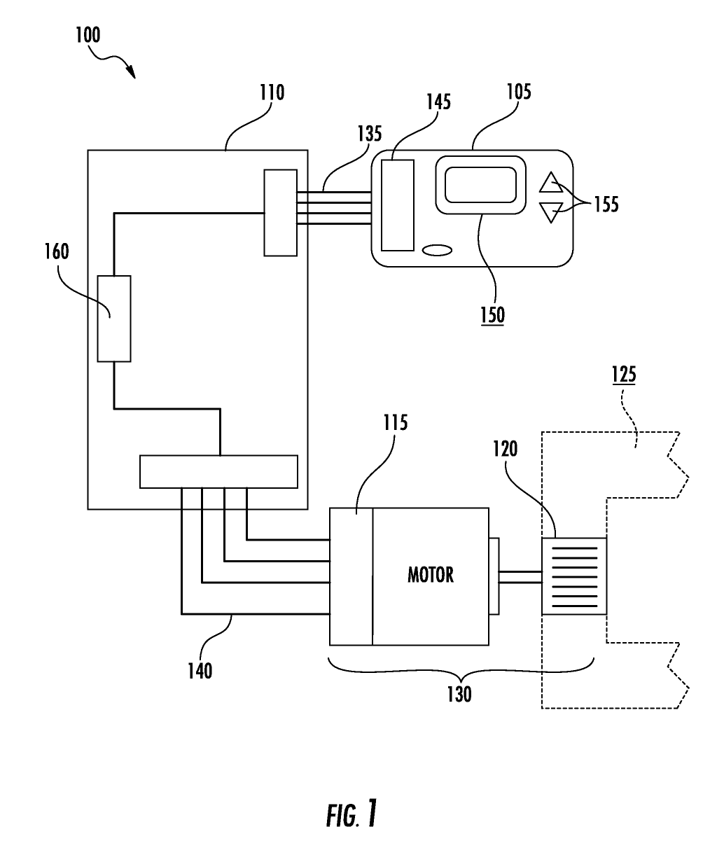

Referring now to the drawings, FIG. 1 illustrates a schematic view of an HVAC system 100 according to an embodiment of the present disclosure. Particularly, the HVAC system 100 includes a system controller or system control unit 105, an air handler controller 110, and a blower system 130 (as part of an air handler) having a variable speed motor 115 and a centrifugal blower 120 connected to the duct system 125. One of ordinary skill will recognize that the air handler or air handler unit, as described herein, refers to any device that distributes air to an interior space and includes such non-limiting examples as a furnace or fan coil. The system control unit 105 is in operative communication with the air handler controller 110 over system communication bus 135, which communicates signals between the system control unit 105 and the air handler controller 110. As a result of the bi-directional flow of information between the system control unit 105 and the air handler controller 110, the algorithms described in illustrated embodiments may be implemented in either control unit 105 or controller 110. Also, in some embodiments, certain aspects of the algorithms may be implemented in control unit 105 while other aspects may be implemented in controller 110.

In one embodiment, the system control unit 105 includes a computing system 145 having a program stored on nonvolatile memory to execute instructions via a microprocessor related to aspects of an airflow rate algorithm to determine the predicted operating parameters of air volume flow, air mass flow, external static pressure load, and operating power consumption of the blower 120 in HVAC system 100. In embodiments, the microprocessor may be any type of processor (CPU), including a general purpose processor, a digital signal processor, a microcontroller, an application specific integrated circuit, a field programmable gate array, or the like.

The system control unit 105 of the illustrated embodiment includes a user interface element 150 such as, for example, a graphic user interface (GUI), a CRT display, a LCD display, or other similar type of interface by which a user of the HVAC system 100 may be provided with system status and/or the determined operating parameters of the air handler. Also, the system control unit 105 includes a user input element 155 by which a user may change the desired operating characteristics of the HVAC system 100, such as airflow requirements. The user may also enter certain specific aspects of the air handler installation such as, for example, the local altitude for operation of the air handler, which may be used in the various algorithms. It is to be appreciated that the system control unit 105 implements aspects of an airflow control algorithm for determining, in an embodiment, the operating parameters including air volume flow rate or air mass flow rate, the blower 120 power consumption, and duct static pressure at the extremes of the operating range of the motor 115 (e.g., at or near maximum motor RPM). The determination of these operating parameters through the algorithms eliminates a need to measure these parameters against published parameters, thereby providing for self-certification of the air handler and diagnostics of the HVAC system 100. The determined operating parameters may be compared to published, expected parameters to provide a certification that the air handler meets the published parameters. It should be appreciated that while aspects of the algorithms described above may be executed in the air handler controller 110, in other embodiments, any of the above algorithms may also be executed in the system control unit 105 without departing from the scope of the disclosure.

Also shown, HVAC system 100 includes the air handler controller 110 operably connected to the blower system 130 for transmitting torque commands to the blower system 130. The air handler controller 110 includes a processor 160 and memory (not shown), which stores operational characteristics of blower system 130 that are specific to the air handler unit model being used. In some non-limiting embodiments, the operational characteristics include blower diameter and blower operating torque. In one embodiment, the air handler controller 110 transmits operation requests to the variable speed motor 115 in the form of a torque command, and receives operating speed of the motor 115 via the motor communication bus 140. The variable speed motor 115 receives operational torque commands from the air handler controller 110 and impels blades of the blower 120 at the commanded motor operating torque. In an embodiment, the processor 160 of the air handler controller 110 implements one or more algorithms for determining the air volume flow rate, air mass flow rate, the static pressure in the duct system 125 over the full range of duct restrictions and airflow range, and operating power consumption by the blower system 130 based on the specific characteristic constants of the air handler unit including characteristics of the specific motor 115 and blower 120 being used.

In an embodiment for an operating mode of the HVAC system 100, the system control unit 105 communicates to the air handler controller 110 a command for a desired indoor airflow. The desired indoor airflow depends on user settings such as, for example, the current operating mode, such as heating, cooling, dehumidification, humidification, circulation fan, outside fresh air intake, etc., the number of stages of heating or cooling, and other factors. In some other operating modes, such as gas heating or electric heating, the system control unit 105 commands the stages of heat and the air handler controller determines the corresponding desired indoor airflow.

Also, the air handler controller 110 is in direct communication with the blower system 130 over motor communication bus 140, which serves to transmit, in one embodiment, torque commands from the air handler controller 110 to the blower system 130. It will be appreciated that the blower system 130 may send operation feedback to the air handler controller 110 such as, in one non-limiting example, the operating speed of the motor 115. In an embodiment, the air handler controller 110 is configured to determine torque command values for the motor 115. Further, in an embodiment, the air handler controller 110 is configured to determine the external static pressure in the duct system 125 that is external to the air handler unit.

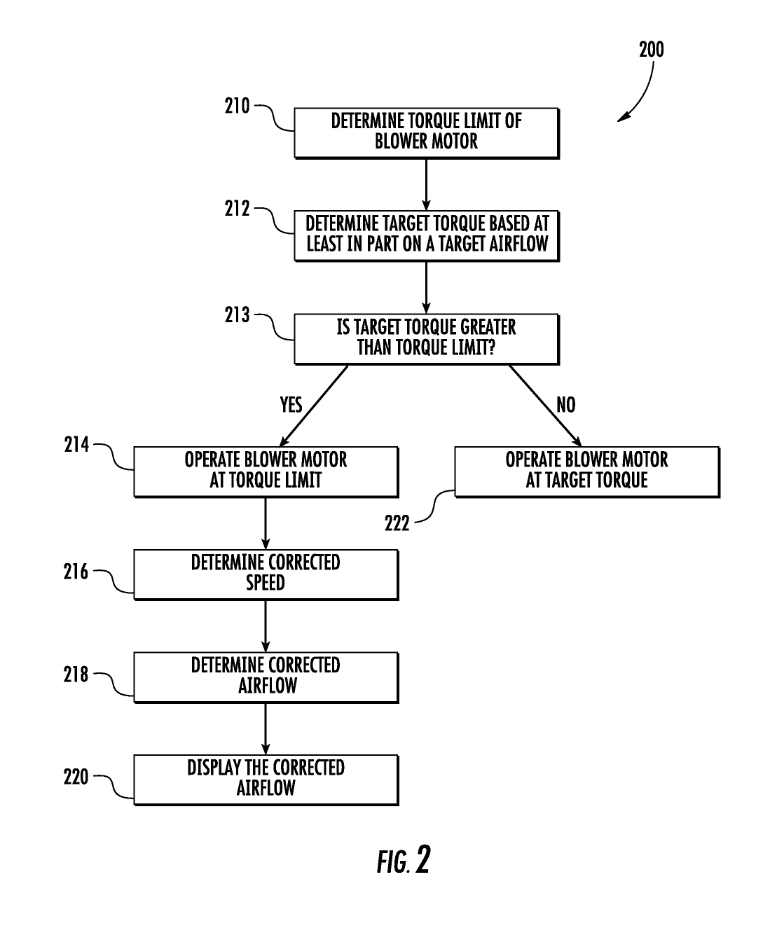

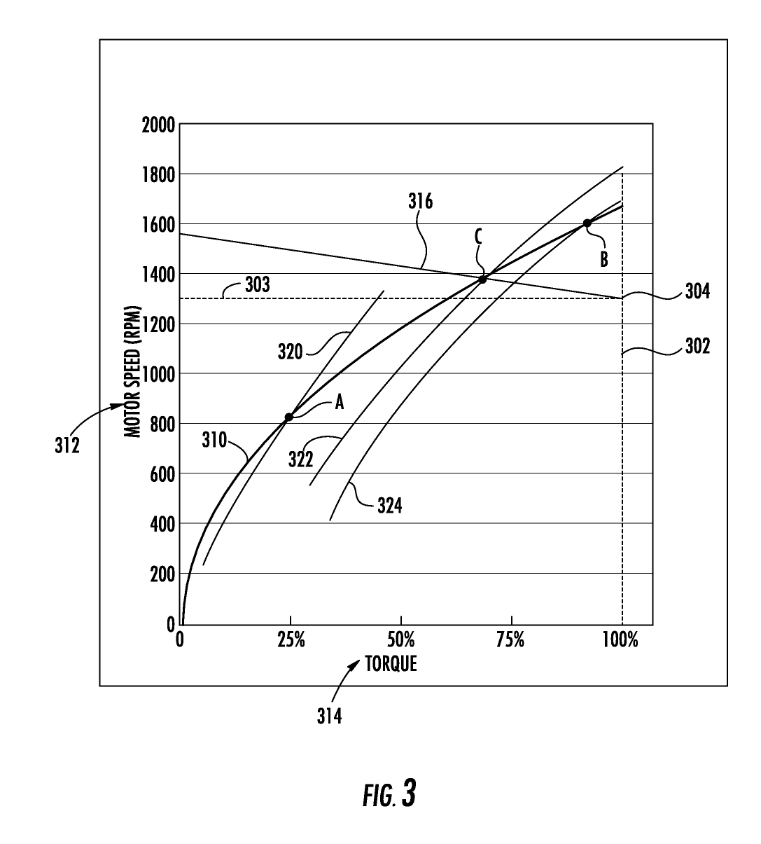

Referring now to FIG. 2, a method 200 is provided for operating a blower motor 115 disposed in an air handling unit in accordance with one or more embodiments of the present disclosure. The method 200 includes determining, at step 210, a torque limit of a blower motor 115 based at least in part on an operational speed of the motor 115. A torque limit protects the blower motor 115 from excessive power consumption and resulting high temperatures. The power consumption of the blower motor 115 is a product of the torque and the operational speed of the blower motor 115. It will be appreciated that the torque limit is not a fixed torque level. In order to protect the blower motor 115, the torque is reduced as the blower motor speed increases, as illustrated by the motor torque limit line 316 shown in FIG. 3 and described in detail below, thereby effectively limiting the power consumed by the blower motor 115.

For example, the torque limit may be determined by retrieving at least one torque limit value. With reference to FIG. 3, a duct square law curve 310 is plotted against motor speed values 312 and motor torque values 314. The motor torque limit line 316 generally represents the maximum allowable torque at which the particular motor 115 should operate. The vertical dashed line 302 of 100 percent of full torque illustrates an absolute torque limit for any motor speed 312. It will be appreciated that the motor torque limit line 316 represents a dynamic motor torque limit line and may vary based on particular conditions, such as line voltage to name one non-limiting example. It will also be appreciated that the values of the torque limit line 316 may be retrieved from the memory of either the air handler controller 110 or the system controller 105. It will also be appreciated that the example shown in FIG. 3 is just one example of operating a blower motor 115.

In one embodiment, determining the torque limit is based at least in part on at least one of a static pressure value from the duct system 125 operably coupled to the air handling unit, extrapolating blower motor speed values correlated with blower motor torque values, and receiving at least one torque limit value from a system controller. For example, with reference to FIG. 3, the HVAC system 100 utilizes the duct square law to relate external static pressure and airflow to the motor speed 312 and the motor torque 314. The duct square law states that the static pressure in the HVAC system 100 varies as the square of the airflow. This law, while a simplification of the more complex relationships between variables, has been proven to be generally valid at the air velocities used in HVAC systems 100. The airflow in the HVAC system 100 is generally proportional to the motor speed 312 and generally proportional to the square root of the motor torque 314.

Continuing with the example, the values along the torque limit line 316 may be determined by determining the maximum speed at which the motor 115 can operate at 100% torque based on motor power consumption requirements (e.g. the maximum RPM may be 1300 revolutions per minute (RPM)). Next, as shown in FIG. 3, the intersection point 304 between the 100% torque line 302 and the line 303 representing 1300 RPM is determined. Then, the torque is reduced from intersecting point 304 by a predetermined factor of approximately 0.17 oz×ft per RPM to establish values to form the torque limit line 316. For a motor speed 312 greater than approximately 1300 RPM, the following calculation may be implemented to determine the values along the torque limit line 316:

Torque limit=100% torque−((motor speed−1300)*(0.17 oz−ft))

It will be appreciated that while the current embodiment of determining a torque limit line 316 illustrates a linear relationship between motor speed 312 and motor torque 314, the relationship may be non-linear and other linear relationships are also possible.

Returning to FIG. 2, the method 200 further includes determining, at step 212, a target torque based at least in part on a target airflow. In one embodiment, the step of determining the target airflow includes receiving a target airflow command from a system controller 105. For example, the air handler controller 110 may receive a desired or target airflow from the system controller 105 over the system communication bus 135. Based on the desired or target airflow, the motor 115 may operate on at least one airflow curve 320, 322, or 324, as shown in FIG. 3. If the required desired or target airflow requires a motor speed 312 between approximately 220-1310 RPM, the motor 115 may operate on airflow curve 320. If the required desired or target airflow requires a motor speed 312 between approximately 550-1810 RPM, the motor 115 may operate on airflow curve 322. If the required desired or target airflow requires a motor speed 312 between approximately 410-1700 RPM, the motor 115 may operate on airflow curve 324. As shown, the duct square law curve 310 intersects the airflow curve 320 below the torque limit line 316, intersects the airflow curve 322 at the torque limit line 316, and intersects the airflow curve 324 above the torque limit line 316. As such, the target torque is selected based on the intersection of the duct square law curve 310 and the airflow curves 320, 322, 324. It will be appreciated that a target airflow may be based at least in part on environmental conditions, such as local altitude or pressure, temperature, and humidity to name a few non-limiting examples.

The air handler controller 110 executes an airflow control algorithm, utilizing various computational formulas for determining operating parameters, such as by utilizing the widely accepted fan laws, for computing target torque values for the motor 115. In some operating modes, the air handler controller 110 may determine the desired airflow without interfacing with the system control unit 105. It will be appreciated that the target torque may also be based at least in part on at least one of a pressure coefficient in the air handling unit and the operating speed of the motor 115.

The method 200 further includes operating, at step 214, the blower motor 115 at the torque limit if it is determined that the target torque is greater than the torque limit at step 213. For example, as shown in FIG. 3, if the requested airflow requires a motor speed 312 of approximately 1600 RPM, the air handler controller 110 determines that the motor 115 would operate at point B on airflow curve 324 as this is the point where the airflow curve 324 intersects the duct square law curve 310. The air handler controller 110 determines that the required torque 314, approximately 90% of full torque, is above the torque limit line 316 for that given motor speed. As a result, the air handler controller 110 determines an appropriate torque along the torque limit line 316 that corresponds to an intersecting point of the duct square law curve 310, one of the airflow curves 320, 322, 324, and the torque limit line 316. In this instance, the appropriate torque along the torque limit line is the intersection point C, which corresponds to airflow curve 322 with a torque value 314 of approximately 65% of full torque. The air handler controller 110 sends a torque limit command signal over the motor communication bus 140 to the motor 115 to cause the blower motor 115 to operate at the determined torque limit, such as the determined torque limit of approximately 65% of full torque at point C shown in FIG. 3.

In one embodiment, the method 200 further includes the step 216 of determining a corrected speed of the motor 115 when the blower motor 115 is operating at the torque limit. For example, after a short stabilization period, the operating speed of the motor 115 may be reported back to the air handler controller 110 over the motor communication bus 140. In the example shown in FIG. 3, after the motor 115 receives the command to operate at the torque value of point C, the motor 115 will then send a signal indicating a corrected motor speed value 312 of about 1400 RPM to the air handler controller 110.

In one embodiment, the method 200 further includes the step 218 of determining a corrected airflow based at least in part on the corrected motor speed. For example, since airflow is proportional to the motor speed 312, the air handler controller 110 may extrapolate the airflow by multiplying a ratio of the corrected speed value 312 to a previously reported speed by the airflow at the point of the previously reported speed. As shown in FIG. 3, the air handler controller 110 determines the corrected airflow value at point C by multiplying a ratio of the corrected motor speed value at point C to the motor speed 312 at point A by the airflow at point A. Based on airflow and motor speed values stored in the memory of the air handler controller 110 and the proportionality of airflow and motor speed, the air handler controller 110 then determines that a corrected airflow value at the torque limit line 316 is approximately 1050 CFM, as represented by airflow curve 322.

In one embodiment, the method 200 further includes the step 220 of displaying the corrected airflow on a user interface element operably coupled to the air handling unit. It will be appreciated that the user interface element may include a display on the air handler controller 110, the system control unit 105, or any device with a graphic user interface (GUI), a CRT display, a LCD display, or other similar type of interface to name a few non-limiting examples.

In one embodiment, the method 200 includes the step 222 of operating the blower motor 115 at the target torque if it is determined that the target torque is less than or equal to the torque limit at step 213. For example, if the target torque is less than or equal to the torque limit, the air handler controller 110 sends a target torque command signal over the motor communication bus 140 to the blower motor 115 to cause the blower motor 115 to operate at the determined target torque. With reference to FIG. 3, if the requested airflow requires a motor speed 312 of approximately 810 RPM, the air handler controller 110 determines that the motor 115 would operate at point A on airflow curve 320 as this is the point where the airflow curve 320 intersects the duct square law curve 310. The air handler controller 110 determines that the required torque, approximately 25% of full torque, is below the torque limit line 316 for that given motor speed. Since the target torque is below the torque limit line 316, the air handler controller 110 sends a torque command signal over the motor communication bus 140 to the motor 115 to cause the blower motor 115 to operate at the determined torque associated with the required motor speed. It will be appreciated that after a short stabilization period, the operating speed of the motor 115, such as a speed of 810 RPM at point A, may be reported back to the air handler controller 110 over the bus 140.

It will be appreciated that the embodiments provided in the present disclosure reduces the probability of exceeding the torque limit of a motor 115 in an air handling unit by operating the motor 115 at a torque limit if the target torque is greater than the torque limit.

While the disclosure has been illustrated and described in detail in the drawings and foregoing description, the same is to be considered as illustrative and not restrictive in character, it being understood that only certain embodiments have been shown and described and that all changes and modifications that come within the spirit of the disclosure are desired to be protected.

What is claimed is:

1. A method for operating a blower motor disposed in an air handling unit, the method comprising the steps:
(a) determining a torque limit of the blower motor based at least partially on an operational speed of the blower motor;
(b) determining a target torque based at least in part on a target airflow; and
(c) operating the blower motor at the torque limit if it is determined that the target torque is greater than the torque limit.

2. The method of claim 1, further comprising (d) operating the blower motor at the target torque if it is determined that the target torque is less than or equal to the torque limit.

3. The method of claim 1, wherein determining the torque limit of the blower motor is based at least in part on at least one of a static pressure value, extrapolating blower motor speed values correlated with blower motor torque values, and receiving at least one torque limit value from a system controller.

4. The method of claim 1, wherein the target airflow includes a target airflow command received from a system controller.

5. The method of claim 1, wherein step (c) further comprises determining a corrected speed of the blower motor.

6. The method of claim 5, further comprising determining a corrected airflow based on at least one of the corrected speed and the torque limit.

7. The method of claim 6, further comprising:
displaying the corrected airflow on a user interface element operably coupled to the air handling unit.

8. An air handler unit comprising:
a blower unit;
a motor operably coupled to the blower unit; and
a controller in electrical communication with the motor;
wherein the controller is configured to:
determine a torque limit of the motor based at least partially on a speed of the motor;
determine a target torque based at least in part on a target airflow; and
operate the motor at the torque limit if it is determined that the target torque is greater than the torque limit.

9. The air handler unit of claim 8, wherein the controller is further configured to operate the motor at the target torque if it is determined that the target torque is less than or equal to the torque limit.

10. The air handler unit of claim 8, wherein the torque limit is based at least in part on at least one of a static pressure value, extrapolating a plurality of blower motor speed values correlated with a plurality of blower motor torque values, and receiving at least one torque limit value from a system controller.

11. The air handler unit of claim 8, wherein the target airflow includes a target airflow command received from a system controller operably coupled to the controller.

12. The air handler unit of claim 8, wherein the controller is further configured to determine a corrected speed when the motor operates at the torque limit.

13. The air handler unit of claim 12, wherein the controller is further configured to determine a corrected airflow based on at least one of the corrected speed and the torque limit.

14. A controller for use within an air handler comprising:
a processor;
a memory; and
executable software stored in the memory, wherein the executable software determines a torque limit of a motor based at least partially on a speed of the motor, determines a target torque based at least in part on a target airflow, and transmits a torque limit operation signal to the motor causing the motor to operate at the torque limit if it is determined that the target torque is greater than the torque limit.

15. The controller of claim 14, wherein the executable software transmits a target torque operation signal to the motor causing the motor to operate at the target torque if it is determined that the target torque is less than or equal to the torque limit.

16. The controller of claim 14, wherein the torque limit is based at least in part on at least one of a static pressure value, extrapolating a plurality of blower motor speed values correlated with a plurality of blower motor torque values, and receiving at least one torque limit value from a system controller.

17. The controller of claim 14, wherein the target airflow comprises a received target airflow command.

18. The controller of claim 14, wherein the executable software determines a corrected airflow based on at least one of a corrected speed and the torque limit.
